(19) United States
(12) Patent Application Publication
(10) Pub. No.: US 2026/0370346 A1
(43) Pub. Date: Nov. 19, 2026

(54) SYSTEM AND METHOD FOR COMMUNICATION BETWEEN QUANTUM CONTROLLER MODULES

(71) Applicant: Q.M Technologies Ltd., Tel Aviv-Yafo (IL)

(72) Inventors: Itamar Sivan, Tel Aviv-Yafo (IL); Yonatan Cohen, Tel Aviv-Yafo (IL); Nissim Ofek, Tel Aviv-Yafo (IL); Ori Weber, Tel Aviv-Yafo (IL); Guy Osi, Tel Aviv-Yafo (IL)

(21) Appl. No.: 19/411,565

(22) Filed: Dec. 8, 2025

Related U.S. Application Data
(63) Continuation of application No. 18/134,679, filed on Apr. 14, 2023, now Pat. No. 12,494,850.
Application No. 18/134,679 is a continuation of application No. 17/242,547, filed on Apr. 28, 2021, now Pat. No. 11,671,180.

(51) Int. Cl. H04B 10/70; G06N 10/00; H04L 7/00

(52) U.S. Cl. CPC H04B 10/70; G06N 10/00; H04L 7/0087; H04L 7/0091

(57) ABSTRACT

A channel between quantum controller modules (e.g., pulse processors) is operable to communicate high speed data required for processing qubit states that may be distributed across a quantum computer. The latency of the communication channel is deterministic and controllable according to a system clock domain.

### BACKGROUND

Limitations and disadvantages of conventional approaches to communication between quantum controller modules will become apparent to one of skill in the art, through comparison of such approaches with some aspects of the present method and system set forth in the remainder of this disclosure with reference to the drawings.

### BRIEF SUMMARY

Systems and methods are provided for communication between quantum controller modules, substantially as illustrated by and/or described in connection with at least one of the figures, as set forth more completely in the claims.

### BRIEF DESCRIPTION OF THE DRAWINGS

FIG. 1 illustrates an example system that supports communication between quantum controller modules in accordance with various example implementations of this disclosure.

FIG. 2 illustrates an example transceiver that supports communication between quantum controller modules in accordance with various example implementations of this disclosure.

FIG. 3 illustrates an example phase shifter for use in a transceiver that supports communication between a plurality of quantum controller modules in accordance with various example implementations of this disclosure.

FIG. 4 illustrates an example method for communication between quantum controller modules in accordance with various example implementations of this disclosure.

FIG. 5 illustrates an example method for initialization and calibration of a transceiver line in accordance with various example implementations of this disclosure.

### DETAILED DESCRIPTION

Classical computers operate by storing information in the form of binary digits (“bits”) and processing those bits via binary logic gates. At any given time, each bit takes on only one of two discrete values: 0 (or “off”) and 1 (or “on”). The logical operations performed by the binary logic gates are defined by Boolean algebra and circuit behavior is governed by classical physics. In a modern classical system, the circuits for storing the bits and realizing the logical operations are usually made from electrical wires that can carry two different voltages, representing the 0 and 1 of the bit, and transistor-based logic gates that perform the Boolean logic operations.

Logical operations in classical computers are performed on fixed states. For example, at time 0 a bit is in a first state, at time 1 a logic operation is applied to the bit, and at time 2 the bit is in a second state as determined by the state at time 0 and the logic operation. The state of a bit is typically stored as a voltage (e.g., 1 V_{dc} for a “1” or 0 V_{dc} for a “0”). The logic operation typically comprises of one or more transistors.

Obviously, a classical computer with a single bit and single logic gate is of limited use, which is why modern classical computers with even modest computation power contain billions of bits and transistors. That is to say, classical computers that can solve increasingly complex problems inevitably require increasingly large numbers of bits and transistors and/or increasingly long amounts of time for carrying out the algorithms. There are, however, some problems which would require an infeasibly large number of transistors and/or infeasibly long amount of time to arrive at a solution. Such problems are referred to as intractable.

Quantum computers operate by storing information in the form of quantum bits (“qubits”) and processing those qubits via quantum gates. Unlike a bit which can only be in one state (either 0 or 1) at any given time, a qubit can be in a superposition of the two states at the same time. More precisely, a quantum bit is a system whose state lives in a two dimensional Hilbert space and is therefore described as a linear combination α|0 [symbol] +β|1 [symbol] , where |0 [symbol] and |1 [symbol] are two basis states, and a and B are complex numbers, usually called probability amplitudes, which satisfy |α|²+|β|²=1. Using this notation, when the qubit is measured, it will be 0 with probability |α|² and will be 1 with probability |β|². The basis states |0 [symbol] and |1 [symbol] can also be represented by two-dimensional basis vectors

$$[ \begin{matrix}1 \\ 0\end{matrix} ] and [ \begin{matrix}0 \\ 1\end{matrix} ] ,$$

respectively. The qubit state may represented by

$$[ \begin{matrix}α \\ β\end{matrix} ] .$$

The operations performed by the quantum gates are defined by linear algebra over Hilbert space and circuit behavior is governed by quantum physics. This extra richness in the mathematical behavior of qubits and the operations on them, enables quantum computers to solve some problems much faster than classical computers. In fact, some problems that are intractable for classical computers may become trivial for quantum computers.

Unlike a classical bit, a qubit cannot be stored as a single voltage value on a wire. Instead, a qubit is physically realized using a two-level quantum mechanical system. For example, at time 0 a qubit is described as

$$[ \begin{matrix}{α}_{1} \\ {β}_{1}\end{matrix} ] ,$$

at time 1 a logic operation is applied to the qubit, and at time 2 the qubit is described as

$$[ \begin{matrix}{α}_{2} \\ {β}_{2}\end{matrix} ] .$$

Many physical implementations of qubits have been proposed and developed over the years. Some examples of qubits implementations include superconducting circuits, spin qubits, and trapped ions.

A quantum controller (QC) generates the precise series of external signals, usually pulses of electromagnetic waves and pulses of base band voltage, to perform the desired logic operations (and thus carry out the desired quantum algorithm).

A quantum programming subsystem is operable to generate a quantum algorithm description which configures the QC and includes instructions the QC can execute to carry out the quantum algorithm (i.e., generate the necessary outbound quantum control pulse(s)) with little or no human intervention during runtime. In an example implementation, the quantum programming system is a personal computer comprising a processor, memory, and other associated circuitry (e.g., an x86 or x64 chipset). The quantum programming subsystem then compiles the high-level quantum algorithm description to a machine code version of the quantum algorithm description (i.e., series of binary vectors that represent instructions that the QC's hardware can interpret and execute directly).

The quantum programming subsystem may be coupled to the QC via an interconnect which may, for example, utilize a universal serial bus (USB), a peripheral component interconnect (PCIe) bus, wired or wireless Ethernet, or any other suitable communication protocol.

The QC comprises circuitry operable to load the machine code quantum algorithm description from the programming subsystem via the interconnect. Then, execution of the machine code by the QC causes the QC to generate the necessary outbound quantum control pulse(s) that correspond to the desired operations to be performed on the quantum processor (e.g., sent to qubit(s) for manipulating a state of the qubit(s) or to readout resonator(s) for reading the state of the qubit(s), etc.). Depending on the quantum algorithm to be performed, outbound pulse(s) for carrying out the algorithm may be predetermined at design time and/or may need to be determined during runtime. The runtime determination of the pulses may comprise performance of classical calculations and processing in the QC during runtime of the algorithm (e.g., runtime analysis of inbound pulses received from the quantum processor).

During runtime and/or upon completion of a quantum algorithm performed by the QC, the QC may output data/results to the quantum programming subsystem. In an example implementation these results may be used to generate a new quantum algorithm description for a subsequent run of the quantum algorithm and/or update the quantum algorithm description during runtime.

A QC may comprise a plurality of pulse processors, which may be implemented in a field programmable gate array, an application specific integrated circuit or the like. A pulse processor is operable to control outbound pulses that drive a quantum element (e.g., one or more qubits and/or resonators). A pulse processor is also operable to receive inbound pulses from a quantum element.

Each pulse processor may share data, metadata and computational values with one or more other pulse processors and make joint decision regarding the control flow and the quantum data sent to the quantum elements. Pulse processors may, therefore, be operable synchronously. Because a QC only has a limited set of pulse processors, one QC may only be operable control a quantum device with a limited number of quantum elements.

In some scenarios however, the quantum algorithm may require multiple pulse processors across a plurality of QC's to perform joint processing. A large number of parallel operations may be required across these multiple QC's.

A QC involves analog converters and a large amount of logic, which may not be integrated into a single device. Therefore, a distributed design approach may be used together with communication channels to support it. To allow data distribution with seamless functionality, a communication channel needs to support chip-to chip, board-to-board and device-to-device interfaces that may include optical transceivers and fiber as the physical channel. Therefore, a need exists for communication protocol that supports a high bandwidth communication channel with low latency. The physical layer of such a protocol may comprise a AC-coupled serial input and/or output with a bandwidth of 16 GHz or higher, an end-to-end deterministic latency of 40 ns or less and a single reference clock synchronized to both ends in the interface. Additional support logic supporting higher layers of the protocol may be implemented in an FPGA.

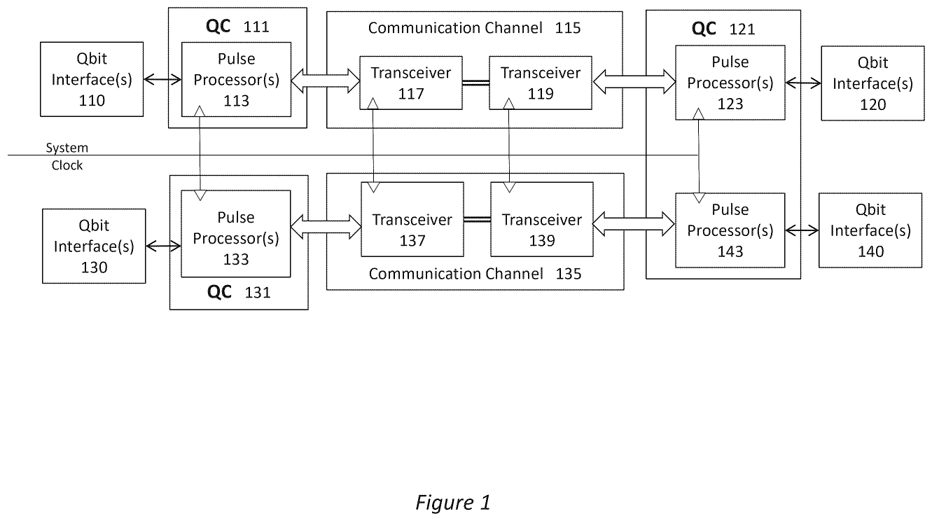

FIG. 1 illustrates an example quantum computer system that supports communication between quantum controller modules in accordance with various example implementations of this disclosure. FIG. 1 illustrates a number of pathways for communication among pulse processors 113, 123, 133 and 143 across communication channels 115 and 135. Pulse processors 113, 123, 133 and 143 and communication channels 115 and 135 remained synchronized by a system clock, which may operate at 250 MHz, for example.

A first QC 111 may comprise a first set of one or more pulse processors 113. A second QC 121 may comprise a second set of one or more pulse processors 123. Communication channel 115 couples the first set of one or more pulse processors 113 to the second set of one or more pulse processors 123. The communication channel 115 comprises a first transceiver 117, a second transceiver 119 and a transmission medium such as optical fiber. A serial data stream may be communicated over the optical fiber at 16 Gb/s.

The first transceiver 117 is operable to convert a plurality of data, from the first set of one or more pulse processors 113, into an analog signal representing a serial data stream. The plurality of data may be associated with a first qubit that is coupled to qubit interface(s) 110. The second transceiver 119 is operable to receive the analog signal representing the serial data stream and convert this signal into a plurality of received data from the first set of one or more pulse processors 113. The second set of one or more pulse processors 123 is operable to control a second qubit, that is coupled to qubit interface(s) 120, according to the plurality of received data.

Data can flow from the first set of one or more pulse processors 113 to the second set of one or more pulse processors 123 as described above. Transceivers 117 and 119 may be bidirectional, such that data can also flow from the second set of one or more pulse processors 123 to the first set of one or more pulse processors 113 in a similar fashion.

A quantum computer may comprise a plurality of communication channels 115 and 135. An additional channel 135 may enable communication with additional pulse processors 133 and 143 that may control additional qubit interfaces 130 and 140. These additional pulse processors 133 may be located a new QC 131 that is operably coupled to a single channel 135. These additional pulse processors 143 may also be located a QC 121 that is operably coupled to two channels 115 and 135.

The first set of one or more pulse processors 113 is operable to generate the plurality of data according to a quantum state estimate of a first group of one or more qubits. Alternatively, the plurality of data may be based on a signal sent by the first set of one or more pulse processors 113 to control the first group of one or more qubits via the qubit interface 110. The plurality of data may also comprise a plurality of instructions and/or metadata. A synchronization of the pulse processors 113 and 123 may be according to these instructions and/or metadata. For example, pulse processor 113 is operable to generate the plurality of data of a sync operation with the pulse processor 123 to allow sending signals to control qubits or to compute state estimation of the qubits in a synchronized manner.

A qubit state may be measured by, for example: probing a resonator that is coupled to the qubit, counting photons emitted by the qubit, or using a single electron transistor near a quantum dot qubit. A single photon detector or a camera may be used to translate photons to an electric signal measured by the controller.

The second set of one or more second pulse processors 123 is operable to generate a signal for the control of a second group of one or more qubits according to the plurality of received data. The second set of one or more pulse processor 123 may also generate a result according to the plurality of received data and a quantum state estimate of the second group of one or more qubits.

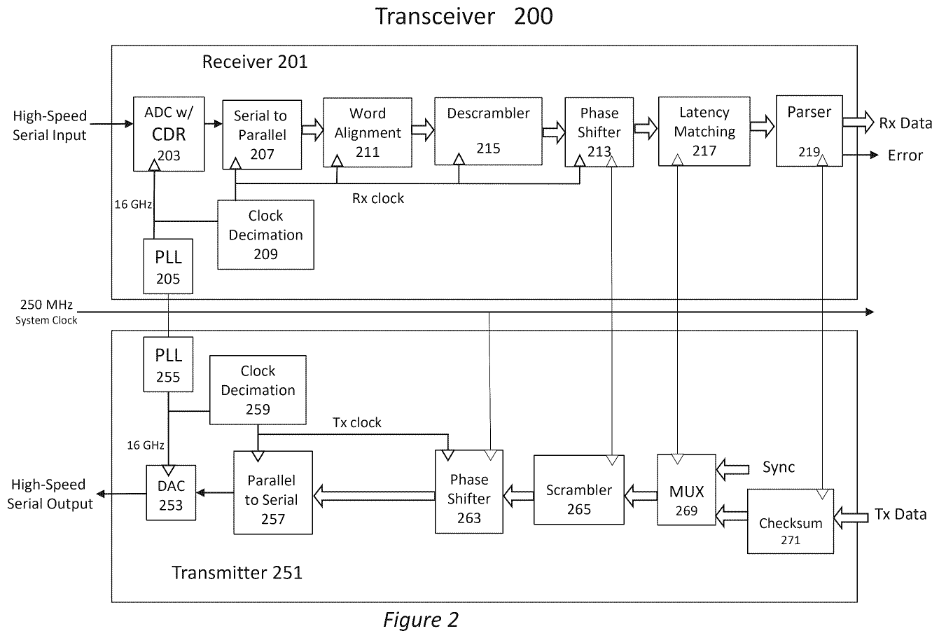

FIG. 2 illustrates an example transceiver 200 (e.g., transceivers 117, 119, 127 and 129 in FIG. 1) that supports communication between quantum controller modules (e.g., pulse processors 113, 123, 133 and 143 in FIG. 1) in accordance with various example implementations of this disclosure. As illustrated, transceiver 200 comprises a receiver 201 and a transmitter 252.

The receiver 201 comprise an analog to digital converter (ADC) 203, a first phase locked loop (PLL) 205, a serial to parallel converter 207, a first clock decimation circuit 209, a word alignment circuit 211, a first phase shifter 213, a descrambler 215, a latency matching circuit 217 and a parser 219.

The transmitter 251 comprises a digital to analog converter (DAC) 253, a second PLL 255, a parallel to serial converter 257, a second clock decimation circuit 259, a second phase shifter 263, a scrambler 265, a multiplexor 269 and circuitry for adding an error check sequence.

The first PLL 205 generates a sampling frequency for the ADC 203 based on the system clock. For example, the first PLL 205 may generate a 16 GHz sampling frequency based on a 250 MHz system clock. The clocking of the serial to parallel converter 207 is based on the generated sample frequency. For example, the first clock decimation circuit 209 may generate a 250 MHz receive clock that is derived from the 16 GHz sampling frequency. As a result, 64 different phases are possible between the 250 MHz system clock and the 250 MHz receive clock. The phase may also vary for every reset and power up. The first phase shifter 213 overcomes the phase difference by crossing from the receive clock domain to the system clock domain while minimizing latency.

The second PLL 255 generates a DAC frequency for the DAC 253 based on the system clock. For example, the second PLL 255 may generate a 16 GHz sampling frequency based on a 250 MHz system clock. The clocking of the parallel to serial converter 257 is based on the generated DAC frequency. For example, the second clock decimation circuit 259 may generate a 250 MHz transmit clock that is derived from the 16 GHz DAC frequency. As a result, 64 different phases are possible between the 250 MHz system clock and the 250 MHz transmit clock. As with the receive clock, the phase may also vary for every reset and power up. The second phase shifter 263 overcomes the phase difference by crossing from the system clock domain to the transmit clock domain while minimizing latency.

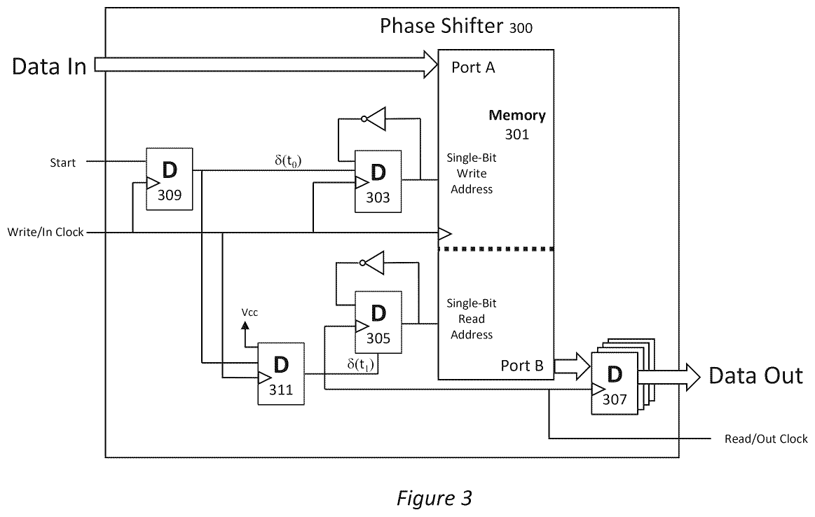

FIG. 3 illustrates an example phase shifter 300 (e.g., phase shifters 213 and 263 in FIG. 2) that supports communication between a plurality of quantum controller modules (e.g., pulse processors 113, 123, 133 and 143 in FIG. 1) in accordance with various example implementations of this disclosure.

The phase shifter 300 comprises a dual port distributed RAM 301 with a depth of 2, and with a write address entry and a read address entry. A flip-flop 303, clocked by the input data clock, is used to generate the write address of a single bit. A flip-flop 305, clocked by the output data clock, is used to generate the read address of a single bit. This memory 301 has a one cycle write on port A and an asynchronous read to a multi-bit flip-flop 307, equal to the memory bus width, on port B. Read and writes operations may be done simultaneously.

The memory write address is initiated by the rising edge of a start signal at t₀. The start signal is synchronized to the write clock. In parallel, the memory read address is initiated by the falling edge of the start signal at t₁. Therefore, a ½ clock period gap exist between a write and any following reads initiated by the read clock. The read cycle will be begin on the rising edge of the read clock, thereby insuring a latency of up to 1 clock cycle system wide. The total latency added by the phase shifter 300 is between zero and one clock cycle according to the phase difference between the write clock and the read clock. In the case of a multi-channel receiver, all channels must be aligned to the maximum latency to ensure the latency is deterministic and minimized.

The phase shifter 300 (e.g., phase shifters 213 and 263 in FIG. 2) is enabled by the initialization of the Clock Domain Crossing (CDC). Once the read and write clocks are running, a Start signal is sampled (by flop-flop 309) on the rising edge of the write clock to initiate the write to the memory. In parallel, the Start signal is sampled (by flop-flop 311) on the following negative edge of the write clock, thereby insuring ½ clock period gap between a write and any following read initiated by the read clock.

The read cycle will be done on the immediate rising edge of the read clock, thereby insuring a latency of up to 1 clock cycle system-wise. Turning back now to FIG. 2. If both the RX phase shifter 213 and the TX phase shifter 263 have read clocks in the right phase to catch the written data, no latency is added by the CDC. If either the RX phase shifter 213 or the TX phase shifter 263 have a delay relative to the system clock, 1 clock cycle of system latency is added. If both the RX phase shifter 213 and the TX phase shifter 263 have a delay relative to the system clock, 2 clock cycles of system latency is added.

The phase shifter 213 is operable to receive parallel data according to the clock domain of receiver clock and transfer the parallel data according to the clock domain of the system clock. The phase shifter 263 is operable to receive parallel data according to the clock domain of system clock and transfer the parallel data according to the clock domain of the transmit clock.

The scrambler 265 and descrambler 215 enables AC coupling of the high-speed analog signal, and maintain CDR functionality over time. The scrambler 129 and the descrambler 113 may apply a multiplicative scrambler polynomial, such as, for example, 1+Z⁻³⁸+Z⁻⁵⁷.

To enable a high bandwidth using a single stream, the ADC 203 of the receiver 201 performs clock and data recovery (CDR) from the serial stream. The serial input received by the ADC 203 includes a known preamble that enable the CDR to lock. This preamble word is unscrambled. An example 128 bit preamble is the sequence:
0x55555555555555550505050505050505.

By using a known preamble, the word aliment circuit 211 is able to select the beginning of a data word of, for example, 64 bits. The word alignment circuit 211 may comprise 1 multiplexer per bit of the data word.

The receiver 201 is initialized by, first, locking the PLL 205. The receiver then monitors for the preamble. The receiver latency is determined according to the variability due to clock domain crossing between the interface clocks and the system clock. The transmission medium may introduce additional time of flight latency. The maximal latency value in cycles is matched by the latency matching circuit 217.

The serial output from the transmitter 251 may include a progressing timestamp counter that is shared across multiple channels for synchronization of a plurality of QC's. The maximal difference between the received timestamp and a locally generated timestamp across every communication channel contributes to the determination of the maximal latency in the system. This difference may indicate that a maximal latency is set too low and the calibration process should restart. Each receive channels, in a multi-channel system, may be delayed a different number of cycles. The entire system may be calibrated to have a fixed delay of maximal latency cycles.

Transmission errors may be identified by add a CRC and/or a checksum. For example, the checksum circuit 271 may generate a 8 bit checksum over the lower 56 bits of a 64 bit word. At the receiver, the parser 219 may regenerate the 8 bit checksum over the lower 56 bits of a 64 bit word received. If the regenerated checksum does not match the received checksum, an error is flagged.

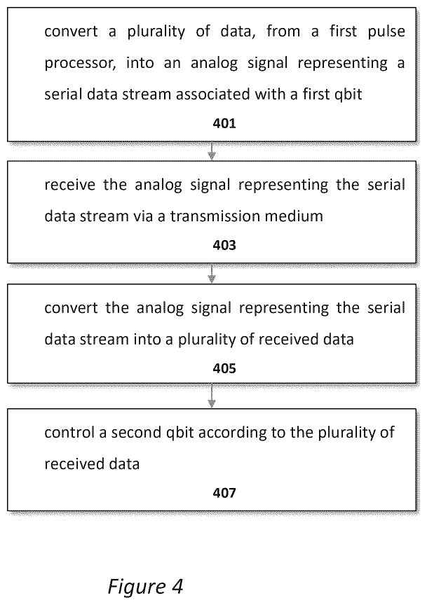

FIG. 4 illustrates an example method for communication between quantum controller modules in accordance with various example implementations of this disclosure.

At 401, a plurality of data, from a first pulse processor, is converted into an analog signal representing a serial data stream associated with a first qubit. The plurality of data may comprise a quantum state estimate of the first qubit and/or data according to the quantum state estimate of the first qubit. The plurality of data may also comprise information related to an signal used to control a qubit. The analog signal representing the serial data stream may be transmitted according to an independent clock domain.

At 403, the analog signal representing the serial data stream is received via a transmission medium, such as an optical fiber. The plurality of data may be communicated over the transmission medium at 16 Gb/s.

At 405, the analog signal representing the serial data stream is converted into a plurality of received data. The plurality of data may be sampled according to a first clock domain. The sampled data may then be transferred to a QC according to a second clock domain such as a system clock. This clock domain transfer enables a transmitter and a receiver to be synchronized via the system clock.

At 407, a second qubit is controlled according to the plurality of received data. The second qubit may be controlled by generating a signal for the second qubit according to the plurality of received data. For example, a pulse processor may be operable to generate an electromagnetic signal for transmission to the second qubit or a device that controls the second qubit such as an acousto-optic modulator (AOM) that modulates a laser beam.

Further results may be generated according to the plurality of received data and a quantum state estimate of the second qubit.

While this disclosure describes an exemplary system with direct communication between two QCs, the disclosed systems and methods are also applicable to communication between more than two QCs, for example via a switch.

This disclosure is able to achieve minimal and deterministic latency using high speed transceivers (e.g., gigabit transceivers, “GTs”) connecting two or more devices. As described above, the total latency added by the phase shifter 300 is between zero and one clock cycle according to the phase difference between the write clock and the read clock. This means that the latency of sending data from one device to another is the base transceiver latency. The cable latency and a non-deterministic latency may be between 0-2 clock cycles, which results from the clock uncertainty for the clock domain crossing between the read and write clock and the system clock, at each side (transmit and receive).

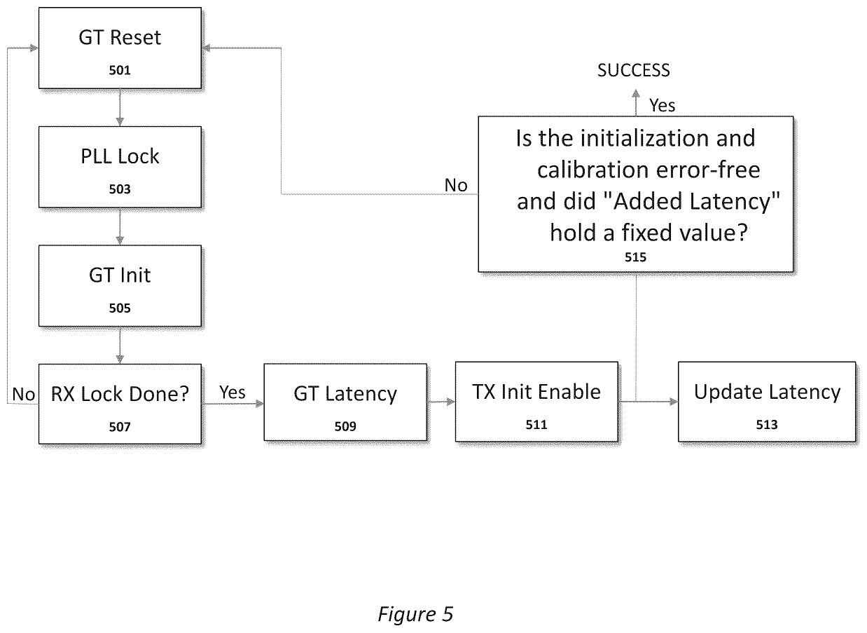

In order to achieve deterministic communication, which is a key factor for quantum algorithms, the following initialization and calibration method is disclosed. FIG. 5 illustrates an example method for initialization and calibration of a transceiver line in accordance with various example implementations of this disclosure.

At first, the two transceivers (TX and RX) are reset via a software register write (i.e., “GT Reset”) at 501. Following the reset, the PLL of the transceiver will lock at 503. The TX clock on the transmitting side and the RX clock on the receiving side are generated by the reference clock, and each have an unknown phase. For instance, for a transceiver at 16 GHz and internal read/write clock of 250 MHz (equal to the system clock frequency), the RX and TX clock can each have any of 64 possible phases. Alternatively, the system clock at both devices may be phase aligned to the same 250 MHz as they are generated by the same clocking source.

At 505, software will initiate a register write called “GT Init,” thereby causing the TX side to send the known and unscrambled preamble and the “word alignment” (211 in FIG. 2) of the receiver will be able to lock at the beginning of a data word.

When the receiver is able to locate the beginning of the stream, it will update a register called “RX Lock Done” at 507. Software may poll on that register looking for a lock. If a lock cannot be achieved, software will jump back to the beginning and will restart the process at 501.

When software detects that “RX Lock Done” is asserted, software will configure a “GT Latency” register at 509. The “GT Latency” register specifies the maximal latency for the communication (GT IP intrinsic latency+medium latency+2 cycles of uncertainty).

Software will then write a register called “TX Init Enable” at 511 causing both devices to transmit the progressing timestamp shared between both devices. Both devices will receive, in their RX channel, the received timestamp from the other device and subtract this value from the original timestamp they are managing. This value is termed as “Delta Timestamp.” Note that the received timestamp is delayed by the latency of sending data from the other device. Subtracting “Delta Timestamp” from the “GT Latency” register value will result in value termed “Added Latency” that will have possible values 0, 1, 2, and specifying the added delay required at the receiver side, to align the latency to the “GT Latency” configured.

Via a software write of “Update Latency” at 513, this “Added Latency” will be stored and from this point forward will be used to ensure a fixed latency which is identical to the “GT Latency” value configured beforehand. At this point, “Update Latency” will be de-asserted and then “TX Init Enable” will also be de-asserted. At this point, the initialization is complete and the functional protocol can be executed on both devices with minimal and deterministic latency allowed between two end points.

During the time that “Update Latency” is asserted, the stability of the “Added Latency” may be monitored and stored in “GT Initialization Status.” Software ensures “Update Latency” is asserted for sufficient period of time to check for errors. If there is an error in the initialization and calibration and “Added Latency” did not hold a fixed value for that time at 515, “GT Initialization Status” will assert and software will initiate the calibration process again by repeating the process at 501.

In practice, there are many GT channels for each FPGA device. For instance, 17 FPGA devices can be connected together if each FPGA has 16 GT lines. At each FPGA, each line will be used for direct communication to all other 16 FPGAs.

The flow described above to initiate and calibrate a single GT line can now be used to align all GT communication lines in parallel. Only lines that had errors in their initialization process will repeat this process and the global initialization and calibration process will complete where all GTs are fully calibrated. In case there are many devices connected, a variation of the medium is allowed (for instance one cable with the length of 2 meters and another with the length of 8 meters, alternatively the type of communication can also vary). As long as the maximal latency of the medium is known, all possible GTs can be calibrated to the maximal “GT Latency” whereas the maximal variation of the “Added Latency” may now be larger than the value of 2.

Also, an indirect GT topology may be used. Instead of direct communication, an indirect communication can be used for much larger scale up. As described above, 16GT lines of 1 FPGA can connect to 16 FPGAs. As an example configuration, the 16 FPGAs may be functional controllers and the 1 FPGA may act as a quantum controller routing switch. With this example configuration, it is possible to cascade multiple building blocks of 16 controllers and a switch. For instance, 256 controllers can communicate through 16 switches when the stream of data has an 8-bit address for the communication destination. More degrees of switches are of course supported in this flow.

To minimize latency in a Xilinx transmitter, extra functionality (e.g., input buffer, FIFO, scrambling and/or encoding) may be eliminated. To minimize latency in a Xilinx receiver, extra functionality (e.g., output buffer, FIFO, clock correction, descrambling, channel bonding, word alignment and/or decoding) may be eliminated. However, removing functionality may result in higher error probability both in the initialization and calibration phase and in the functional phase.

The initialization and calibration flow is tolerant of errors due to its repetitive nature and the fact that the initialization and calibration process average time is typically negligible compared to the software compiling and loading time.

Errors in the functional phase may also be monitored and/or corrected by incorporating error detection and correction schemes (e.g., parity, checksum and/or error correction algorithms) as part of the stream data bus. Identifying errors may be sufficient for quantum algorithms, as long as the error probability is sufficiently low. Due to the probabilistic nature of the qubits, many repetitions of the same flow may be required to collect sufficient statistics. For example, if the same flow requires 10,000 iterations, it is acceptable to run it 10,001 times and neglect a single run that ended with errors.

The I/O interface receives high speed serial input and unfolds it to a parallel bus. There are few cycles of uncertainty caused by the clock-domain-crossing from the slow to fast clock in the transmitting side and from the fast to slow clock in the receiving side. The upper bound of the latency accounts for the transmitter/receiver circuitry and the propagation delay through the connectors and medium. Each QC has a timestamp counter that is synchronized with the timestamp counters of every other QC via an external clock source. A sync trigger is used to align both the internal clock phase of the controller and reset the timestamp counter. During calibration, two connected QCs send each other their aligned timestamp. Each QC receives the timestamp and compares it to its own timestamp. The QCs' own timestamp will be X cycles higher, as the received timestamp from another QC is delayed by the latency of sending the data. That X is subtracted from the known max latency, Y. The receiver side delays the transaction by Y cycles. Thus, the latency of all connections in the system is known. Therefore, the upper bound maximum communication latency is deterministic. In a given system with multiple communication paths (over potential different medium), the system may be synchronized according to a maximal latency. Given a deterministic latency, several QCs may operate together seamlessly with an expandable number of pulse processors. The communication channels may also comprise a QC switch and/or a shared resource, such as for joint computations.

The present method and/or system may be realized in hardware, software, or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical implementation may comprise one or more application specific integrated circuit (ASIC), one or more field programmable gate array (FPGA), and/or one or more processor (e.g., x86, x64, ARM, PIC, and/or any other suitable processor architecture) and associated supporting circuitry (e.g., storage, DRAM, FLASH, bus interface circuits, etc.). Each discrete ASIC, FPGA, Processor, or other circuit may be referred to as “chip,” and multiple such circuits may be referred to as a “chipset.” Another implementation may comprise a non-transitory machine-readable (e.g., computer readable) medium (e.g., FLASH drive, optical disk, magnetic storage disk, or the like) having stored thereon one or more lines of code that, when executed by a machine, cause the machine to perform processes as described in this disclosure. Another implementation may comprise a non-transitory machine-readable (e.g., computer readable) medium (e.g., FLASH drive, optical disk, magnetic storage disk, or the like) having stored thereon one or more lines of code that, when executed by a machine, cause the machine to be configured (e.g., to load software and/or firmware into its circuits) to operate as a system described in this disclosure.

As used herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As used herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As used herein, the term “exemplary” means serving as a non-limiting example, instance, or illustration. As used herein, the terms “e.g.,” and “for example” set off lists of one or more non-limiting examples, instances, or illustrations. As used herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.). As used herein, the term “based on” means “based at least in part on.” For example, “x based on y” means that “x” is based at least in part on “y” (and may also be based on z, for example).

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1-32. (canceled)

33. A scalable quantum control system comprising:
a plurality of quantum controllers, each quantum controller comprising one or more pulse processors configured to control one or more quantum elements;
a plurality of communication channels coupling the plurality of quantum controllers;
a common clock source configured to synchronize respective timestamp counters of the plurality of quantum controllers; and
latency calibration circuitry configured to:
determine, for each communication channel of the plurality of communication channels, channel-specific communication timing information according to a timestamp received via the communication channel and a local timestamp generated at a receiving quantum controller,
establish a common deterministic latency for the plurality of communication channels according to the channel-specific communication timing information, and
cause data received via each of the plurality of communication channels to be processed according to the common deterministic latency,
wherein the plurality of quantum controllers is configured to perform synchronized quantum control operations according to the data processed according to the common deterministic latency.

34. The scalable quantum control system of claim 33, wherein, for at least one communication channel, the latency calibration circuitry is configured to delay the data received via the at least one communication channel by a channel-specific added latency.

35. The scalable quantum control system of claim 34, wherein the channel-specific added latency corresponds to a difference between the common deterministic latency and a measured communication latency of the at least one communication channel.

36. The scalable quantum control system of claim 33, wherein, for at least one communication channel, the latency calibration circuitry is configured to cause the received data to be processed according to the common deterministic latency without adding latency to the at least one communication channel.

37. The scalable quantum control system of claim 36, wherein the latency calibration circuitry is configured to determine, according to the timestamp received via the at least one communication channel and the local timestamp, whether the received data satisfies a timing criterion associated with the common deterministic latency.

38. The scalable quantum control system of claim 33, wherein the channel-specific communication timing information comprises a difference between the timestamp received via the respective communication channel and the local timestamp generated at the receiving quantum controller.

39. The scalable quantum control system of claim 33, wherein the common deterministic latency is at least as great as a maximum communication latency associated with the plurality of communication channels.

40. The scalable quantum control system of claim 33, wherein the plurality of communication channels comprises communication channels having different propagation latencies.

41. The scalable quantum control system of claim 33, wherein at least one communication channel of the plurality of communication channels comprises an optical transceiver and an optical transmission medium.

42. The scalable quantum control system of claim 33, comprising a quantum controller routing switch coupled between at least a first quantum controller and a second quantum controller of the plurality of quantum controllers, wherein at least a portion of the data is communicated indirectly between the first quantum controller and the second quantum controller via the quantum controller routing switch.

43. A method for operating a scalable quantum control system, the method comprising:
synchronizing respective timestamp counters of a plurality of quantum controllers using a common clock source, wherein the scalable quantum control system comprises the plurality of quantum controllers coupled by a plurality of communication channels;
receiving, at respective receiving quantum controllers of the plurality of quantum controllers, timestamps transmitted via the plurality of communication channels;
determining channel-specific communication timing information for the plurality of communication channels according to the received timestamps and respective local timestamps of the receiving quantum controllers;
establishing a common deterministic latency according to the channel-specific communication timing information;
causing data received via the plurality of communication channels to be processed according to the common deterministic latency; and
performing, by the plurality of quantum controllers, synchronized quantum control operations according to the data processed according to the common deterministic latency.

44. The method of claim 43, wherein causing the data received via the plurality of communication channels to be processed according to the common deterministic latency comprises selectively adding latency to data received via at least one, but fewer than all, of the plurality of communication channels.

45. The method of claim 43, wherein causing the data received via the plurality of communication channels to be processed according to the common deterministic latency comprises processing data received via at least one communication channel without adding latency to the at least one communication channel.

46. The method of claim 45, comprising validating the data received via the at least one communication channel according to whether a timing of the data corresponds to the common deterministic latency.

47. The method of claim 43, comprising:
monitoring the channel-specific communication timing information during a calibration interval; and
repeating a calibration operation for a communication channel in response to determining that the channel-specific communication timing information for the communication channel does not remain fixed during the calibration interval.

48. The method of claim 43, wherein establishing the common deterministic latency comprises selecting a latency that accounts for transceiver latency, propagation latency through a transmission medium, and clock-domain-crossing uncertainty.

49. A quantum controller comprising:
one or more pulse processors configured to control one or more quantum elements;
a transceiver configured to communicate data with one or more additional quantum controllers via one or more communication channels;
a timestamp counter synchronized, by a common clock source, with respective timestamp counters of the one or more additional quantum controllers; and
latency control circuitry configured to:
determine communication timing information for a communication channel according to a timestamp received by the transceiver and a local timestamp of the timestamp counter, and
cause data received via the communication channel to be made available to the one or more pulse processors according to a deterministic latency common to a plurality of communication channels of a quantum control system.

50. The quantum controller of claim 49, wherein the latency control circuitry is configured to selectively delay the data received via the communication channel according to a difference between the deterministic latency and a measured latency represented by the communication timing information.

51. The quantum controller of claim 49, wherein the latency control circuitry is configured to make the data received via the communication channel available without adding latency to the communication channel and to determine whether the data satisfies a timing condition associated with the deterministic latency.

52. The quantum controller of claim 49, wherein the one or more pulse processors are configured to generate, according to the data received via the communication channel, at least one of:
a signal for controlling a quantum element;
a quantum state estimate associated with the quantum element;
a result based on the quantum state estimate; or
synchronization information for coordinating a quantum control operation with another quantum controller.
